(19) United States
(12) Patent Application Publication
(10) Pub. No.: US 2011/0232701 A1
(43) Pub. Date: Sep. 29, 2011

(54) MASTIC-LESS DISHWASHER PROVIDING INCREASING ENERGY EFFICIENCY AND INCLUDING A RECYCLABLE AND RECLAIMABLE TUB

(75) Inventors: Mario Ascander Colon, Raleigh, NC (US); Charles Goodyear, Kinston, NC (US); Joseph Stanley Fulton, Kinston, NC (US); Jerry Lee Olesen, Kinston, NC (US)

(73) Assignee: Electrolux Home Products, Inc.

(21) Appl. No.: 13/153,768

(22) Filed: Jun. 6, 2011

Related U.S. Application Data
(63) Continuation-in-part of application No. 12/360,700, filed on Jan. 27, 2009, now Pat. No. 7,981,222.
Application No. 12/360,700 is a continuation-in-part of application No. 12/362,262, filed on Jan. 29, 2009.
Application No. 12/362,262 is a continuation-in-part of application No. 12/841,883, filed on Jul. 22, 2010.

(51) Int. Cl. A47L 15/42; B23P 17/04; G10K 11/168

(52) U.S. Cl. 134/198; 29/428; 312/228; 181/200

(57) ABSTRACT

Embodiments of a mastic-less dishwasher are provided. The dishwasher may include a mastic-less material coupled to the dishwasher door or walls of recyclable and/or reclaimable tub. The dishwasher is free of a mastic material such that during operation the dishwasher may provide greater energy efficiency than a dishwasher comprising a mastic material. The mastic-less material may be non-expandable and/or a mass dampener material. Further, related methods for assembling a dishwasher are also provided.

### CROSS-REFERENCE TO RELATED APPLICATIONS

This application is a continuation-in-part of U.S. patent application Ser. No. 12/360,700, filed Jan. 27, 2009, U.S. patent application Ser. No. 12/362,262, filed Jan. 29, 2009, and U.S. patent application Ser. No. 12/841,883, filed Jan. 22, 2010, all of which are hereby incorporated herein in their entirety by reference.

### BACKGROUND

The present disclosure relates to dishwashers and more particularly to structures and methods configured to attenuate and reduce sound generated from use of dishwashers and improve energy efficiency while reducing environmental impact.

One issue of interest in the field of dishwashers is to reduce the externally perceptible noise generated by the dishwasher when the dishwasher is in use. Due to the number of mechanical devices cooperating to circulate the water to clean and rinse the dishware within the dishwasher, the sources and conduits of sound are numerous and determining ways to reduce the noise may be challenging.

Further, another issue of interest is the reduction of energy usage required to operate dishwashers. In this regard, water may be heated in order to clean dishes. When the dishwasher is designed to reduce heat losses to the external environment around the dishwasher, the energy expended to heat the water may be reduced.

One material which has been employed in an attempt to reduce noise emissions from dishwashers and insulate against heat loss therefrom is that of mastic materials. Mastic materials, which may also be referred to as bitumen materials, are presently used in dishwashers because they are believed to absorb sound and insulate the dishwashers. However, mastic materials may have certain disadvantages.

### BRIEF SUMMARY

Embodiments of a mastic-less dishwasher are provided herein. In one embodiment, the mastic-less dishwasher includes a recyclable and/or reclaimable tub comprising a plurality of walls defining a washing chamber configured to receive and hold a plurality of dishware and an opening. Further, the mastic-less dishwasher includes a door movable between an open position configured to provide access to the washing chamber through the opening, and a closed position configured to substantially close the opening and a mastic-less material coupled to at least one of the door and the walls of the recyclable and/or reclaimable tub external to the washing chamber. The mastic-less material may be non-expandable, and the dishwasher may be free of a mastic material such that during operation the mastic-less material does not expand and the dishwasher is configured to provide greater energy efficiency than a dishwasher comprising a mastic material.

In some embodiments, the mastic-less material may comprise a composite acoustic membrane including a layer of an acoustic tape, the acoustic tape comprising a plurality of first fibers extending in a first direction and a plurality of second fibers extending in a second direction, the first and second directions perpendicular to each other form a grid-like pattern, wherein the acoustic tape is positioned and configured to convert at least a portion of a sound power level generated by the dishwasher into heat such that the sound power level outside the dishwasher is reduced. Further, the composite acoustic membrane may include a first foam layer configured to absorb at least a portion of the sound power level and to reduce the speed of the sound power level prior to the sound power level reaching the acoustic tape. Also, the composite acoustic membrane may include a second foam layer and a vinyl layer between the first and second foam layers, the vinyl layer being configured to convert at least a portion of the sound power level into heat.

According to additional embodiments, the mastic-less material may comprise a laminated structure positioned and configured to attenuate a sound power level generated by the dishwasher, the laminated structure including a layer of an acoustic tape, the acoustic tape comprising a non-fibrous layer and a plurality of fibers mounted thereon, and wherein the plurality of fibers is configured to convert at least a portion of a sound power level generated by the dishwasher into heat such that the sound power level outside the dishwasher is reduced. Further, at least one of the door and the walls of the recyclable and/or reclaimable tub may define an inner wall that is exposed to the washing chamber, wherein an air gap is defined between the inner wall and the mastic-less material. At least one of the door and the walls of the recyclable and/or reclaimable tub may further define an intermediate wall defined between the inner wall and the mastic-less material. Also, at least one of the door and the walls of the recyclable and/or reclaimable tub may further define an outer wall configured to be exposed to an outside environment, wherein the mastic-less material is positioned between the intermediate wall and the outer wall and configured to contact both the intermediate wall and the outer wall. Further, the mastic-less material may comprise a composite cellular membrane comprising a cell layer positioned between a first reflective layer and a second reflective layer.

In some embodiments, the door and the walls of the recyclable and/or reclaimable tub include a plurality of stainless steel panels. A base tray may be configured to manage and control thermo-acoustic waves associated with noise generated by the dishwasher in an operational state, wherein the thermo-acoustic waves comprise vibrations and/or sound waves. The base tray may comprise a major surface and an array of thermo-acoustic nodes disposed on the major surface and defined by a plurality of rows and a plurality of columns, at least two of the thermo-acoustic nodes being interconnected and configured to channel the thermo-acoustic waves therebetween so as to control and manage the thermo-acoustic waves, thereby attenuating the noise associated with the thermo-acoustic waves.

In another embodiment, the mastic-less dishwasher further includes a water conduit and a fluid inlet in communication with the washing chamber and the water conduit, the fluid inlet comprising a nozzle defining a combination of a first plurality of orifices and a second plurality of orifices that define a diameter that is relatively larger than the diameter of the first plurality of orifices, wherein, during a filling cycle of the dishwasher, water is transmitted along the water conduit through the nozzle to the washing chamber. Each of the first plurality of orifices and the second plurality of orifices may define a constant cross-section in a water inflow direction. Further, the nozzle may comprise an inner surface and an outer surface, wherein each of the first plurality of orifices extends from the inner surface to the outer surface and defines a constant cross-section there along, and wherein each of the second plurality of orifices extends from the inner surface to the outer surface and defines a diverging cross-section there along. Additionally, the mastic-less material may be coupled directly to a bare structure of at least one of the door and the walls of the recyclable and/or reclaimable tub external to the washing chamber.

In an additional embodiment, a mastic-less dishwasher includes a recyclable and/or reclaimable tub comprising a plurality of walls defining a washing chamber configured to receive and hold a plurality of dishware and an opening. A door may be moveable between an open position configured to provide access to the washing chamber through the opening, and a closed position configured to substantially close the opening. A mass dampener material may be coupled to at least one of the door and the walls of the recyclable and/or reclaimable tub, wherein the mass dampener material comprises a mastic-less material, and wherein the dishwasher is free of a mastic material such that during operation the dishwasher is configured to provide greater energy efficiency than a dishwasher comprising a mastic material. For example, the mass dampener material may includes a vinyl layer configured to convert at least a portion of a sound power level generated by the dishwasher into heat such that the sound power level outside the dishwasher is reduced.

In another embodiment, a method for assembling a mastic-less dishwasher is provided. The method may include providing a recyclable and/or reclaimable tub comprising a plurality of walls defining a washing chamber configured to receive and hold a plurality of dishware and an opening. Further, the method may include providing a door movable between an open position configured to provide access to the washing chamber through the opening, and a closed position configured to substantially close the opening. Additionally, the method may comprise coupling a mastic-less material to at least one of the door and the walls of the recyclable and/or reclaimable tub external to the washing chamber, wherein the mastic-less material is non-expandable, and wherein the dishwasher is free of a mastic material such that during operation the dishwasher is configured to provide greater energy efficiency than a dishwasher comprising a mastic material.

In some embodiments, coupling the mastic-less material may comprise coupling the mastic-less material without causing the mastic-less material to be compressed by the walls of the recyclable and/or reclaimable tub or the door. Further, coupling the mastic-less material may comprise placing a composite acoustic membrane in a position external to the washing chamber, the composite acoustic membrane configured to convert at least a portion of the sound generated by the dishwasher into heat, the composite acoustic membrane comprising a layer of an acoustic tape, the acoustic tape including a plurality of first fibers extending in a first direction and a plurality of second fibers extending in a second direction. The method may also include providing a base tray comprising a major surface and an array of thermo-acoustic nodes disposed on the major surface and defined by a plurality of rows and a plurality of columns, at least two of the thermo-acoustic nodes being interconnected, wherein the base tray is configured to channel a plurality of thermo-acoustic waves associated with noise generated by the dishwasher in an operational state between the thermo-acoustic nodes so as to control and manage the thermo-acoustic waves and to thereby attenuate the noise associated with the thermo-acoustic waves. Further, the method may include providing a water conduit and providing a fluid inlet in communication with the washing chamber and the water conduit, the fluid inlet comprising a nozzle defining a combination of a plurality of relatively small-diameter orifices and a plurality of relatively large-diameter orifices, the water conduit configured to transmit water to the washing chamber through the nozzle during a filling cycle. Additionally, coupling the mastic-less material to at least one of the door and the walls of the recyclable and/or reclaimable tub external to the washing chamber may comprise coupling the mastic-less material directly to a bare structure of at least one of the door and the walls of the recyclable and/or reclaimable tub external to the washing chamber.

As such, aspects of the present disclosure may provide significant advantages as otherwise detailed herein.

### BRIEF DESCRIPTION OF THE SEVERAL VIEWS OF THE DRAWING(S)

Reference will now be made to the accompanying drawings, which are not necessarily drawn to scale, and wherein:

FIG. 1 is a perspective view of a dishwasher of a type suitable for use with various embodiments of the present invention;

FIG. 2 is a perspective view of an embodiment of a tub of the dishwasher of FIG. 1 without insulating materials in accordance with one exemplary embodiment;

FIG. 3A is a cross-sectional view of a composite acoustic membrane consistent with various exemplary embodiments;

FIG. 3B is a bottom view of the composite acoustic membrane of FIG. 3A, wherein an acoustic tape layer is visible in accordance with various exemplary embodiments;

FIG. 4 is a cross-sectional view through a door of the dishwasher of FIG. 1 consistent with an exemplary embodiment;

FIG. 5 is a perspective view of a section of a composite cellular membrane in accordance with an exemplary embodiment;

FIG. 6 is a perspective view of an inner portion of a door with the composite cellular membrane of FIG. 5 coupled thereto in accordance with an exemplary embodiment;

FIG. 7 is a partial exploded view of the dishwasher of FIG. 1 in accordance with various exemplary embodiments;

FIG. 8 is a plan view of one embodiment of a base tray, wherein the base tray includes an array of thermo-acoustic nodes in accordance with various exemplary embodiments;

FIG. 9 is a cross-sectional view through a fluid inlet in accordance with various exemplary embodiments;

FIG. 10 is an enlarged cross-sectional view of an embodiment of a nozzle of the fluid inlet of FIG. 9 in accordance with various exemplary embodiments;

FIG. 11 is a bar graph illustrating the expected annual energy usage associated with various exemplary embodiments of dishwashers; and

FIG. 12 is an embodiment of a method for assembling a dishwasher in accordance with various exemplary embodiments.

### DETAILED DESCRIPTION

The present disclosure now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Applicant has identified certain disadvantages associated with the conventional use of mastic materials, also known as bitumen, in dishwashers. In this regard, sheets of mastic materials may be applied externally to dishwashers and/or inserted within the door and/or wall cavities of the dishwasher in an attempt to reduce noise emissions from the dishwasher. However, mastic materials may have the undesirable characteristic that they may be rigid, particularly before they warm sufficiently, and hence mastic materials may tend to vibrate and transmit sound. In addition, the present application further demonstrates that mastic materials tend to act as a heat sink. In this regard, as the dishwasher warms during use, heat is absorbed into the mastic material, removing this heat from a washing chamber of the dishwasher. Therefore, production of additional heat may be required to operate the dishwasher, thereby adversely affecting energy efficiency. Additionally, use of a mastic material may complicate recycling of dishwashers once the dishwashers are removed from service. In this regard, mastic materials may be bonded to the dishwashers in a manner such that removal of the mastic materials involves significant labor and/or expense. Thus, elimination of mastic materials may reduce material and labor costs associated with assembly and disassembly of the dishwashers. Accordingly, embodiments of a dishwasher configured to avoid the problems associated with use of mastic materials are provided herein.

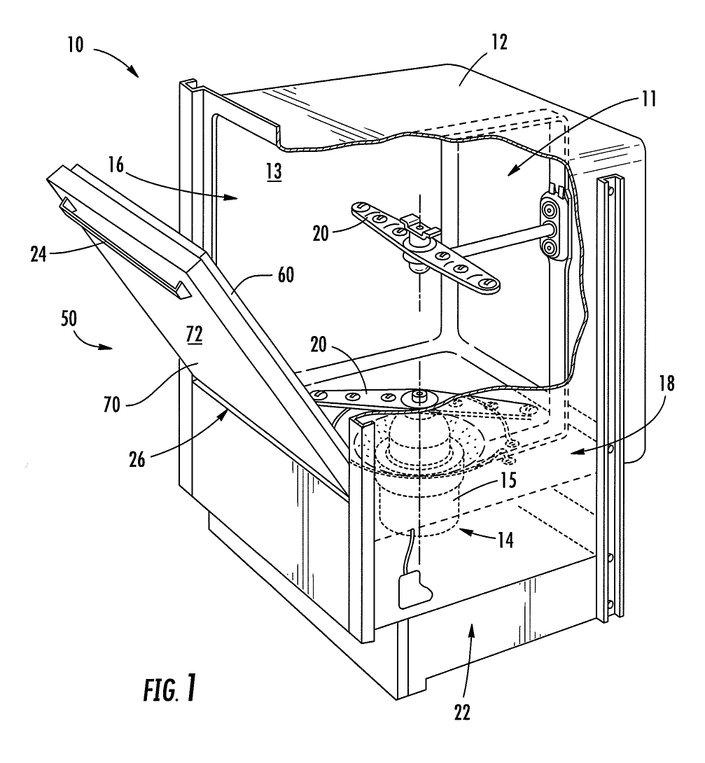

In this regard, FIG. 1 illustrates a dishwasher 10 that may benefit from various embodiments of the present invention. The dishwasher 10 may comprise a tub 13 (partly broken away in FIG. 1 to show internal details) comprising a plurality of walls 12 that define a washing chamber 11 configured to receive and hold a plurality of dishware, such as dishes, cups, and utensils. However, the dishwasher 10 may be employed to wash various other items, as may be understood by one having skill in the art.

The tub 13 may also define an opening, generally designated as 16, through which the dishware may be inserted into and removed from the washing chamber 11. A door 50 may be configurable between an open position configured to provide access to the washing chamber 11 through the opening 16, and a closed position configured to substantially close the opening. In FIG. 1 the door 50 is illustrated in a partially open position.

The dishwasher 10 may also include slidable lower and/or upper racks (not shown) for holding the dishware to be washed. The tub 13 may define a sump, generally designated as 14, in which wash water or rinse water is collected, for example, under the influence of gravity. The wash/rinse water may be pumped by a pump 15 out of the sump 14 to various spray arms 20 mounted in the interior of the tub 13 for spraying the wash/rinse water, under pressure, onto the dishes, utensils, and other dishware contained therein.

The pump 15 and/or other mechanical devices (e.g., a circulation pump, a drain pump, water valve(s)) that provide operational functions for the dishwasher 10 may be housed, disposed, or otherwise positioned within a base 22 positioned beneath the tub 13, wherein the base receives and supports a lower end 18 of the tub 13. In some instances, the base 22 may be a separate component with respect to the tub 13, such as, for example, a molded polymer component, while in other instances the base may be integral with the tub such that the side walls forming the tub also at least partially form the base.

The door 50 may be pivotably engaged with the tub 13 about the lower end 18 of the tub so as to selectively permit access to the washing chamber 11. That is, a lower edge 26 of the door 50 may be pivotably engaged (e.g., hinged) with the lower end 18 of the tub 13 such that the door is pivotable about the lower edge thereof to cover and seal the opening 16 in the closed position when the dishwasher 10 is in operation, and to provide access to the interior of the tub through the opening when the door is pivoted from the closed position to the open position. In some instances, the door 50 may comprise an inner wall 60 and an outer wall 70. The door 50 may include a handle member 24 disposed on an outer surface 72 of the outer wall 70 to provide the user with a grasp portion.

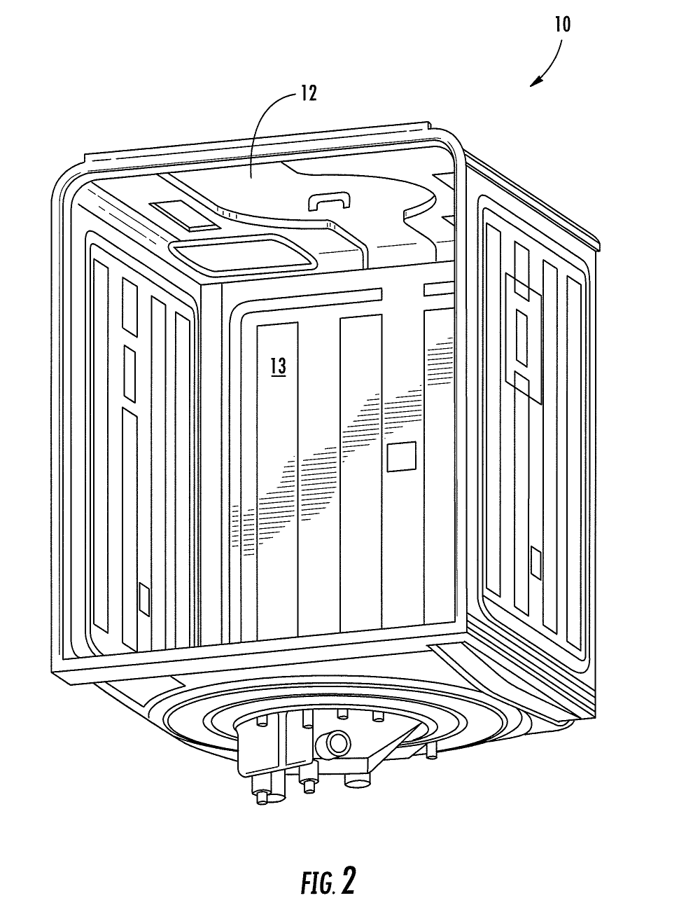

As noted above, Applicant has identified a number of disadvantages associated with use of a mastic material. Accordingly, embodiments of the present disclosure are generally directed to dishwashers that are free of a mastic material, which may be referred to herein as mastic-less dishwashers. For example, the dishwasher 10 described above may not include a mastic material. Accordingly, in one embodiment the dishwasher 10 may be free of an insulating material coupled to the walls 12 of the tub 13. For example, FIG. 2 illustrates an embodiment of the dishwasher 10 with the door 50 removed in order to show the inside of the tub 13. As illustrated, the dishwasher 10 is free of a mastic material or other insulating material coupled to the walls 12 of the tub 13. Alternatively, or additionally, the dishwasher 10 may be free of an insulating material coupled to the door 50. In one embodiment the door 50 and/or the walls 12 of the tub 13 may comprise a plurality of stainless steel panels. However, in other embodiments, various other embodiments of materials may be employed. Accordingly, in some embodiments the dishwasher 10 may be free of a mastic material and the dishwasher may define bare walls 12 and/or a bare door 50 that is/are free of an insulating material. Thus, issues with respect to a mastic material transmitting noise and acting as a heat sink may be avoided. In some embodiments the walls 12 and/or the door 50 may comprise two or more layers with an air gap therebetween acting to thermally and acoustically insulate the dishwasher.

Further, the tub 13 may be recyclable and/or reclaimable. For example, the material forming the tub 13 may be recycled or otherwise processed into a new object, or reclaimed for reuse as a tub in a new dishwasher. In this regard, by avoiding use of a mastic material, issues with respect to removing a mastic material from the tub may be avoided. Thus, the tub 13 provided herein may be considered recyclable and/or reclaimable, whereas the tub of a dishwasher including mastic materials coupled thereto may not be considered recyclable and/or reclaimable because of the cost and/or effort associated with removing the mastic material from the tub.

In a further embodiment, the dishwasher 10 may include a mastic-less material (i.e., an insulting material or emission reduction material that does not include a mastic material) coupled to at least one of the door 50 and the walls 12 of the tub 13, or other portion of the dishwasher. In some embodiments the mastic-less material may be directly coupled to a bare structure of the door, walls, or other portion of the dishwasher 10. For example, the mastic-less material may be adhered thereto through use of glue or other adhesive. Further, in some embodiments the mastic-less material may be installed without requiring use of a heat source. For example, some insulating materials may require heat to expand the material to fit a desired space during use of the dishwasher, while materials such as mastic are baked onto the dishwasher, whereas the mastic-less materials described herein need not necessarily require heat for installation or effectiveness. Accordingly, the door 50 and/or one or more of the walls 12 of the tub 13 of the dishwasher 10 may be insulated by mastic-less materials. Various embodiments of mastic-less materials may be employed, such as the embodiments of mastic-less materials disclosed in U.S. patent application Ser. No. 12/360,600.

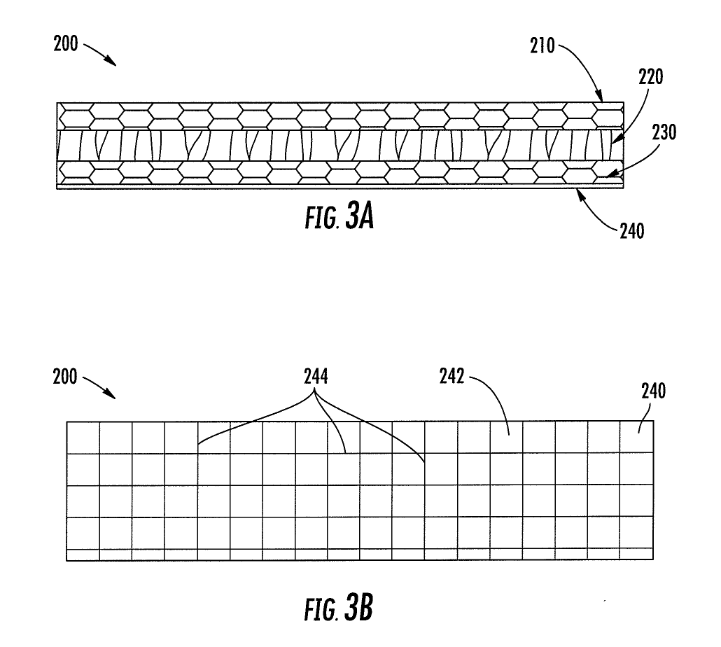

As illustrated in FIGS. 3A and 3B, in one embodiment the mastic-less material may comprise a composite acoustic membrane 200 that includes one or more of a first open cell foam layer 210, a mass loaded vinyl layer 220, a second open cell foam layer 230, and a layer of acoustic tape 240. The vinyl layer 220 may be positioned between the first 210 and second 230 foam layers. Further, the acoustic tape 240 may be positioned adjacent one of the sides of a foam layer (e.g., the second foam layer 230, as shown) opposite the vinyl layer 220. In some embodiments the composite acoustic membrane may comprise a laminated structure whereby the layers 210, 220, 230, 240 thereof are bonded to one another.

Although a mass loaded vinyl layer 220 is generally described herein, various other embodiments of mass dampener materials may be employed in other embodiments. In this regard, other examples of mass dampeners may include viscoelastic composite cushions (single or multilayer), brush seal material, elastometers, gaskets (e.g., die cut), fabric over foam, foam cushions, closed and/or open cell foam, felt, cork, rubber (natural or synthetic), a combination of rubber and vinyl, polyurethane, micro-cellular rubber, polyfoam, neoprene, crosslinked polymer, silicone, solid nitrile and other mastic-less emission reduction materials or combinations thereof. Mass dampener materials, as used herein, refer to materials of relatively high density that are configured to absorb sound and vibrations. Accordingly, use of mass dampener materials in the composite acoustic membrane 200 may reduce noise emissions from the dishwasher 10.

In some embodiments the acoustic tape 240 may be aluminum foil, metallized biaxially-oriented polyethylene terephthalate, or other foil material, with an adhesive backing. The adhesive backing may be used to adhere the acoustic tape 240 to one of the foam layers (e.g., the second foam layer 230, as shown). As illustrated in FIG. 3B, the acoustic tape 240 may further include bi-directional polymer fibers 244 extending in a grid-like pattern (i.e., a plurality of first fibers extend in a first direction and a plurality of second fibers extend in a second direction, wherein the first and second directions are generally perpendicular to each other) throughout or along a face of the foil material 242 or other non-fibrous layer. The composite acoustic membrane 200 according to the illustrated embodiment of FIGS. 3A and 3B may be commercially available through a number of vendors.

The thickness of any of the individual layers of the composite acoustic membrane may vary. For example, the thickness of the layers may be configured such that collectively the thickness of the layers provided an overall thickness such that the composite acoustic membrane occupies a particular cavity or opening of the dishwasher. As another example, the relative thickness of the foam layers may vary depending on the application. In general, each of the foam layers may absorb and decelerate a portion of the sound transmitted through the layer regardless on the direction of the sound. The foam layer on either side of the vinyl layer may absorb and decelerate the sound before it reaches the vinyl layer regardless of the direction of the sound, which may increase the overall effectiveness of the composite acoustic membrane.

In some applications, the sound coming from a particular side of the vinyl layer may be relatively minimal and in such case, the foam layer on that particular side may be relatively thinner than the other foam layer. It should be noted that, in some applications, it is believed that it is beneficial to manage not only the sound transmitted from inside the dishwasher to outside the dishwasher but also the sound transmitted from outside the dishwasher to the inside the dishwasher as well. Sound transmitted from outside the dishwasher to inside the dishwasher may eventually reflect back or otherwise contribute to the level of sound transmitted from the inside the dishwasher to the outside of the dishwasher.

It is believed that the mass loaded vinyl layer 220 of the composite acoustic membrane 200 is effective at absorbing sound at a low frequency (30-300 kilohertz) and the first 210 and second 230 open cell foam layers 210, 230 is effective at absorbing sound at a medium frequency (300-3000 kilohertz). It is also believed that the excess at a high frequency (3-30 megahertz) is transformed into heat which dissipates in two directions along the bi-directional polymer fibers 244 of the acoustic tape 240 and excess noise is attenuated at the intersections of the fibers.

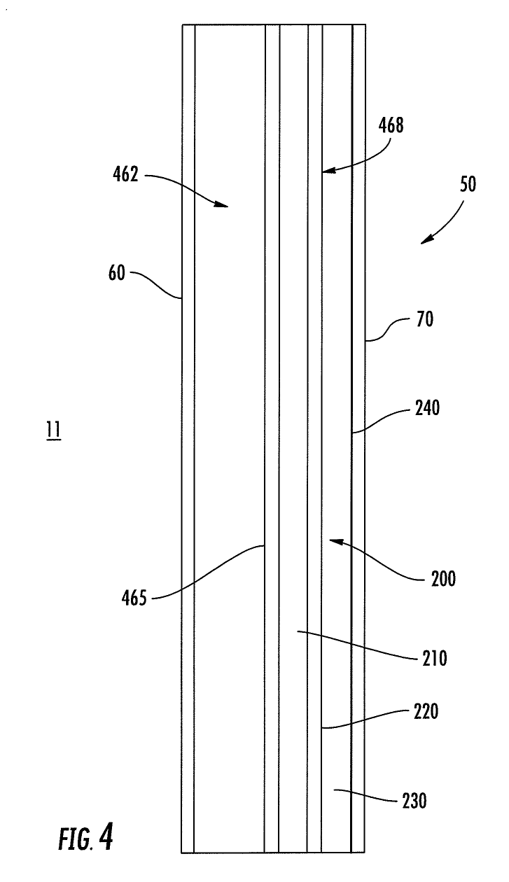

As noted above, the mastic-less material may be configured in a variety of positions in or around the dishwasher 10. In this regard, FIG. 4 illustrates an example embodiment in which the composite acoustic membrane 200 is positioned within the door 50 of the dishwasher 10. As illustrated, the door 50 includes an inner wall 60 which is adjacent and exposed to the washing chamber 11 of the dishwasher 10 and an outer wall 70 which is adjacent and exposed to the outside environment of the dishwasher. According to the illustrated embodiment, the door 50 further includes an intermediate wall 465 extending between the inner 60 and outer 70 walls. Each of the inner 60, intermediate 465, and outer 70 walls of the door 50 may be made from various rigid materials. The inner 60, intermediate 465, and outer 70 walls are spaced from each other so as to define a first cavity 462 between the inner 60 and intermediate 465 walls and a second cavity 468 between the intermediate 465 and outer 70 walls. As illustrated, an air gap may be defined in the first cavity 462 between the inner 60 and intermediate 465 walls. Although not illustrated, the door 50 may include one or more components such as a detergent dispenser, a drying system (e.g., a drying duct), and a user input panel. These components may be supported within the first 462 and/or second 468 cavities in some embodiments.

As noted above, in some embodiments the dishwasher 10 may be free of an insulating material coupled to the door 50, and hence the cavities 462, 468 of the door may be free of an insulating material in some embodiments. However, in embodiments employing an insulating material, the door 50 may include a panel of the composite acoustic membrane 200 positioned within one or both of the cavities 462, 468. For a more specific example and according to the illustrated embodiment of FIG. 4, the composite acoustic membrane 200 may be positioned within the second cavity 468 such that the composite acoustic membrane is positioned between the intermediate wall 465 and the outer wall 70 and configured to contact both the intermediate wall and the outer wall.

The composite acoustic membrane 200 may be shaped and sized that the composite acoustic membrane substantially occupies the entire cavity 468. In embodiments in which the second cavity 468 contains additional components such as a drying system or a dispenser, the composite acoustic membrane 200 may be configured to define openings or shapes such that the composite acoustic membrane extends at least partially around such components or otherwise provides space for the components. Although the composite acoustic membrane 200 may be configured to substantially entirely occupy a cavity within the door 50, the composite acoustic membrane may be configured so as to not be compressed against the walls of the tub or the door. In this regard, by configuring the composite acoustic membrane 200 so as to not be compressed, the tendency of the composite acoustic membrane to transmit vibrations may be reduced. For example, if the composite acoustic membrane were to be compressed between inner and outer walls of a door or a tub, the composite acoustic membrane may transmit vibrations to the outer wall of the door or tub, which could transmit noise to the environment around the dishwasher.

The composite acoustic membrane 200 and other embodiments of mastic-less materials described herein may be non-expandable. Non-expandable insulating materials, as used herein, refer to insulating materials that are not configured to expand or swell during the operation of the dishwasher or during installation therein. In this regard, the mastic-less materials provided herein may not be configured to act as spring dampeners that expand into contact with one or more surfaces, such as to bridge a gap between a dishwasher and an adjacent cabinet. Instead, the mastic-less materials may be configured to reduce noise emissions through other modes of operation as described herein. While some expansion may inherently occur as a result of changes in temperature during operation of the dishwasher, non-expandable insulating materials are not configured or required to expand into contact with one or more surfaces in order to provide noise abatement or other functionality.

According to the illustrated embodiment of FIG. 4, the composite acoustic membrane 200 includes the first open cell foam layer 210 positioned as a first layer configured to act as an incident absorber inbound/outbound geometry capturing a portion of the sound power generated inside the washing chamber 11 of the dishwasher 10, such as water splashing against the door 50. The mass loaded vinyl layer 220 of the composite acoustic membrane 200 is positioned as a second layer and configured to act as a sound power-thermal converter. More specifically, the sound power that reaches the mass loaded vinyl layer 220 may cause the mass loaded vinyl material to vibrate and, thus, convert at least a portion of the sound power into heat. The second open cell foam layer 230 may be positioned as a third layer and configured to act as an incident absorber inbound/outbound geometry capturing a portion of the sound power that is transmitted through the first open cell foam layer 210 and the mass loaded vinyl layer 220 or through the outer wall 70 of the door 50.

The sound power not absorbed or converted into heat by the first open cell foam layer 210, mass loaded vinyl layer 220, and the second open cell foam layer 230 may be transmitted onto the fibers of the acoustic tape 240. In particular, the composite acoustic membrane 200 may include the acoustic tape 240 as a fourth layer including the bi-directional polymer fibers 244 (see, e.g., FIGS. 3A and 3B). In general, the acoustic tape 240 may be configured to provide protection and structural stability to the rest of the composite acoustic membrane 200. However, it is believed that the bi-directional polymer fibers 244 may be positioned and configured to provide an additional benefit. For example, the bi-directional polymer fibers 244 may redirect a portion of the sound power level along the fibers, i.e., in four directions (e.g., up, down, left, right), where it is converted or transformed into heat. Accordingly, the acoustic tape 240 and the other layers 210, 220, 230 of the composite acoustic membrane 200 may be configured to convert at least a portion of a sound power level generated by the dishwasher 10 into heat such that the sounds power level outside of the dishwasher is reduced. Moreover, the acoustic tape 240 may include a reflective foil material which also reflects or refracts a portion of the sound power level. Individually and collectively, the polymer fibers 244 and the foil material may further reduce the sound power level that transmits through the door 50 which may be perceivable to consumers.

The composite acoustic membrane 200 may have a first orientation within the door 50. For example, according to the illustrated embodiment, the acoustic tape layer 240 may be adjacent the outer panel 70 such that the acoustic tape is considered to be facing the outside environment of the dishwasher 10. As another example (not illustrated), in a second orientation, the acoustic tape layer 240 may be adjacent the intermediate panel 465 such that the acoustic tape is considered to be facing the washing chamber 11. In both the first and second orientation, the composite acoustic membrane 200 may include an adhesive, such as a pressure-sensitive adhesive, for adhering the first open cell foam layer 210 to either the outer panel 70 or the intermediate panel 465.

The door 50 may include an additional composite acoustic membrane that is positioned within the first cavity between the inner panel 60 and the intermediate panel 465. In other embodiments, the door 50 may include a panel of expanded polystyrene positioned within the first cavity to further help to insulate the door or to provide additional support or stiffening of the door.

Further, in an additional embodiment, the walls 12 of the dishwasher 10 may comprise two or more walls, for example, the walls 12 defining the tub 13 may include an inner wall and an outer wall. Further, the walls may include an intermediate wall. Thus, the walls 12 may be configured as described above with respect to the door 50 in some embodiments. For example, an air gap may be defined between the inner wall and the intermediate wall. Further, the composite acoustic membrane 200 may be positioned between the intermediate wall and the outer wall as described above. Accordingly, in some embodiments the above-described configuration of the walls and the composite acoustic membrane with respect to the door 50 may additionally or alternatively apply to the walls 12 of the tub 13. Thus, the dishwasher 10 may in some embodiments incorporate a mastic-less material, for example, in accordance with the disclosure of U.S. patent application Ser. No. 12/360,700.

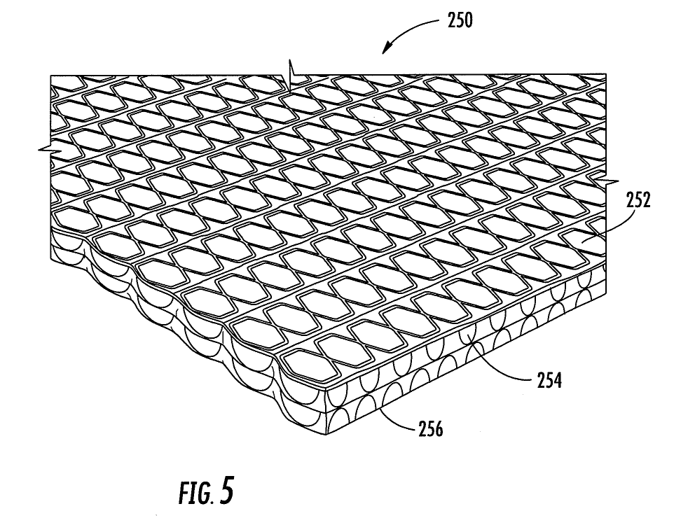

By way of further example, FIG. 5 illustrates another embodiment of a mastic-less material that may be used in the mastic-less dishwasher 10. In particular, FIG. 5 illustrates an embodiment of a composite cellular membrane 250. The composite cellular membrane 250 may comprise multiple layers including a reflective layer 252 comprising a material such as aluminum, copper or gold, and a cell layer 254 comprising cells or bubbles of air trapped in a polymer material. The composite cellular membrane 250 may include a second reflective layer 256 (which may be the same, or similar to, the first reflective layer 252) such that the cell layer 254 is sandwiched between the two reflective layers 252, 256. For example, the composite cellular membrane 250 may also comprise a material including a polymer bubble film laminated between two layers of foil.

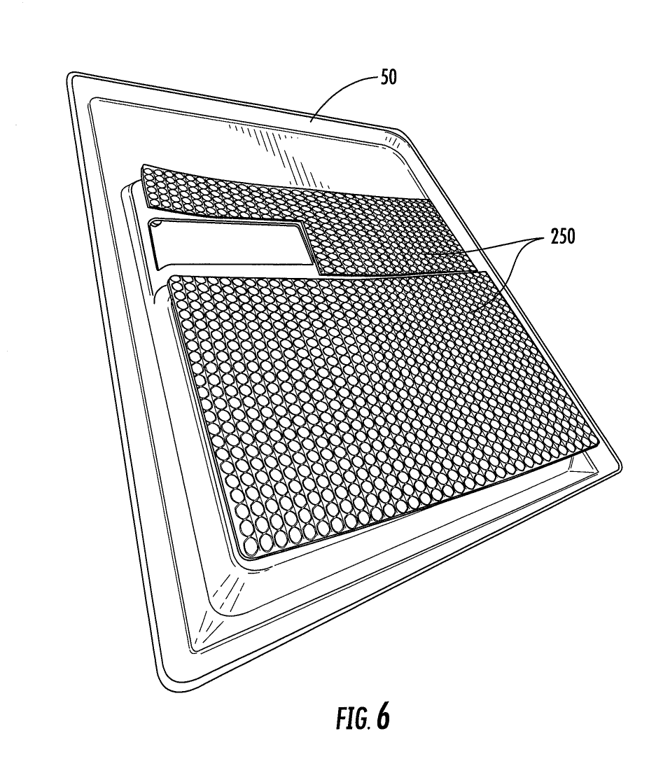

The composite cellular membrane 250 may attach to the walls and/or the door of the dishwasher 10. For example, FIG. 6 illustrates the composite cellular membrane 250 adhered to an inner wall of the door 50. However, the composite cellular membrane 250 may additionally or alternatively be applied to various other portions of the mastic-less dishwasher 10 in some embodiments. For example, the composite cellular membrane 250 (as well as other mastic-less materials discussed herein) may be applied to the base of the mastic-less dishwasher 10, a toe plate, and/or other structures. Further, the mastic-less materials may be applied in flat sheets, as shown in FIG. 6, and/or in strips defining air gaps configured to channel sound and heat so as to more evenly distribute sound and heat within and/or around the mastic-less dishwasher 10.

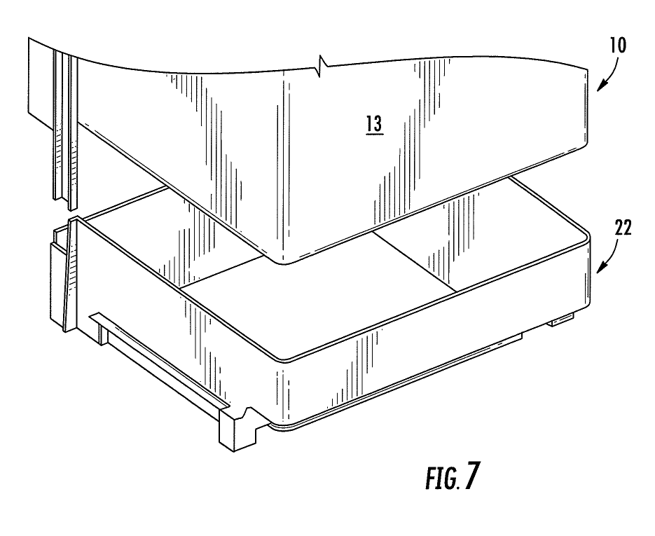

The dishwasher 10 may in some embodiments additionally or alternatively include a base tray, for example, as disclosed in U.S. patent application Ser. No. 12/841,883. In this regard, FIG. 7 illustrates an embodiment of the base 22 when it is separated from the tub 13 of the dishwasher 10. In some instances, the base 22 may be a separate component with respect to the tub 13, such as, for example, a molded polymer component, while in other instances the base 22 may be integral with the tub 13 such that the side walls forming the tub 13 also at least partially form the base 22.

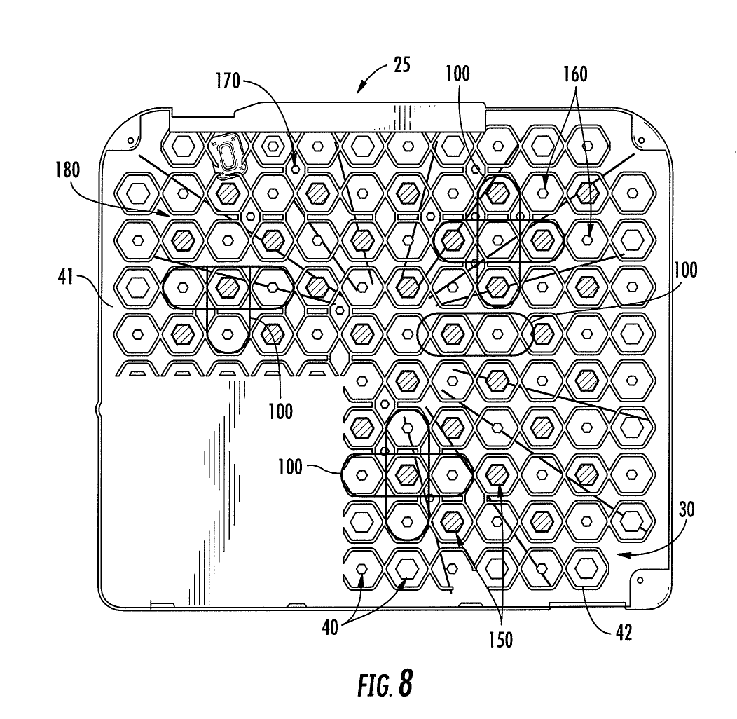

The base 22 may be molded to receive a base tray 25 (see, e.g., FIG. 8) that, in instances of the dishwasher 10 requiring service, may be removed from the bottom of the dishwasher to allow access to the various components received by the base. The base tray 25, besides covering some operational components contained in the base 22 of the dishwasher 10, may also be utilized to manage and control sound waves emitted during operation of the dishwasher. These sound waves can come in the form of vibrations emitted from many different sources during operation of the dishwasher 10, including components of the dishwasher and water flow inside the dishwasher.

One embodiment of a base tray 25 (shown in FIG. 8), is configured to be placed inside the base 22 for attenuating, dissipating, or otherwise reducing the sound/noise generated due to thermo-acoustic waves imparted thereto by the operational components of the dishwasher 10. In the depicted embodiment, the base tray 25 comprises an array 30 of thermo-acoustic nodes 40 disposed on a major surface 41 and configured to reduce the sound generated by the dishwasher 10 during operation. The array 30 may include a plurality of rows and a plurality of columns of thermo-acoustic nodes 40. Additionally, the base tray 25 and the array 30 of thermo-acoustic nodes 40 may be integrally formed from a single piece of material. For example, the base tray 25 and the array 30 can be formed by injection molding or other polymeric processing techniques.

As illustrated, the array 30 of thermo-acoustic nodes 40 may also comprise clusters 100 of thermo-acoustic nodes (circled regions). Clusters 100 comprise adjacent thermo-acoustic nodes 40 or the interconnection of at least two thermo-acoustic nodes, such as by sharing a common outer wall member 42 (i.e., common sides) or having otherwise interconnected wall members. The clusters of the thermo-acoustic nodes 40 encourage sound waves to bounce back and forth between the thermo-acoustic nodes inside the cluster 100 in an effort to control them and eventually cancel out the sound being emitted. In the depicted embodiment, the thermo-acoustic nodes 40 generally form a plurality of rows and a plurality of columns across the array 30. As such, a cluster 100 can occur at any interconnection between at least two thermo-acoustic nodes 40 across either a row or a column.

Furthermore, clusters 100 can occur between any combination of thermo-acoustic nodes 40 in the array. For example, in the depicted embodiments, some but not all clusters 100 are shown in FIG. 8 between low 150 and mid 160 frequency nodes (e.g., a cluster of a low-frequency node 150 and two mid-frequency nodes 160 on opposite sides thereof). Clusters 100 may also be provided between first 170 and second 180 embodiments of high-frequency nodes (e.g., a cluster of one high-frequency node 170 and two alternate high-frequency nodes 180 on opposite sides thereof). Thus, the dishwasher 10 may in some embodiments incorporate a base tray, for example, in accordance with the disclosure of U.S. patent application Ser. No. 12/841,883.

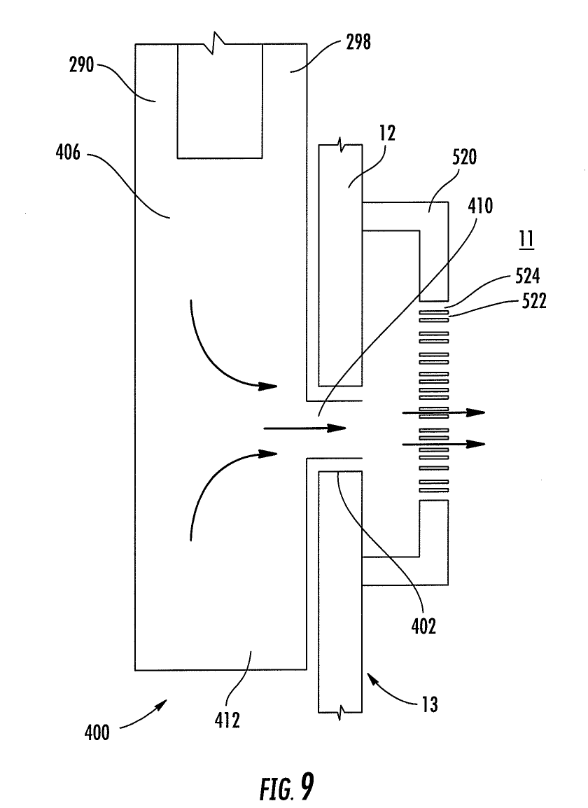

The dishwasher 10 may in some embodiments additionally or alternatively include a fluid inlet, for example, as disclosed in U.S. patent application Ser. No. 12/362,262. In this regard, one or more embodiments of the dishwasher 10 are directed to attenuating acoustic emissions transmitted through a fluid inlet. As illustrated in FIG. 9, the dishwasher 10 may include a fluid inlet 400 configured to cooperate with an opening 402 defined in a side wall 12 of the tub 13. The fluid inlet 400 may include a base 406 that is configured to receive a fluid conduit 290 and an air conduit 298. The base 406 may include an extension portion 410 for extending through the opening 402. The base 406 may also define a cavity or reservoir 412 configured to hold a predetermined amount of water.

The fluid inlet 400 may include a nozzle 520 defining a plurality of orifices 522, 524. The relative sizes and shapes of the orifices 522, 524 may be configured to reduce or manage the acoustic emissions transmitted through or by the nozzle 520. As explained above, the sources of the acoustic emissions may vary internally and externally, e.g., the splashing and transmission of water and the pumps, motors, valves, and other components of the dishwasher 10 and devices and the environment external of the dishwasher. According to the illustrated embodiment of FIGS. 7 and 8, the nozzle 520 defines a combination of a first plurality of orifices 522 interspersed with a second plurality of orifices 524 that define a diameter that is relatively larger than the diameter of the first plurality of orifices.

Water is discharged through the relatively small-diameter orifices 522 and the relatively large-diameter orifices 524 into the tub. Also, the fluid inlet 400 may further function as vent such that air may travel through the relatively small 522 and large 524 orifices into and out of the washing chamber 11. “Relatively,” as used in reference to the orifices, describes the relative sizes of the different size holes to each other, i.e., the orifices of the first plurality of orifices are smaller than the orifices of the second plurality of orifices and thus may be referred to herein as relatively small-diameter orifices 522. Likewise, the orifices of the second plurality of orifices may be referred to herein as relatively large-diameter orifices 524 because the orifices of the second plurality are larger than the orifices of the first plurality.

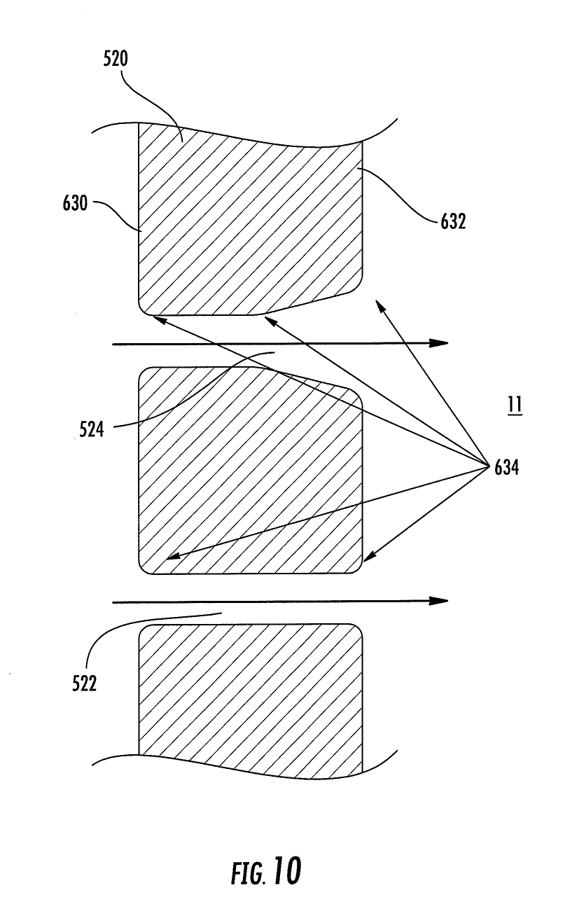

As shown in FIG. 10, according to one embodiment, the relatively small-diameter orifices 522 have a constant cross-section, i.e., the diameter of the orifice remains the same along the length of the orifice from an inner surface 630 (facing away from the washing chamber 11) of the nozzle to an outer surface 632 (facing toward the washing chamber) of the nozzle. As an example, the diameter of a relatively small-diameter orifice may be approximately 0.5 millimeters. The relatively large-diameter orifices 524 may have a diverging cross-section in the water inflow direction. More specifically, the diameter of a relatively large-diameter orifice 524 may increase from the inner surface 630 of the nozzle 520 to the outer surface 632 of the nozzle over at least a portion of the distance between the inner and outer surfaces of the nozzle. As an example, the diameter of a relatively large-diameter orifice 524 may range from approximately 1.5 millimeters at its largest point to approximately 0.5 millimeters at its smallest point. In other embodiments, the relatively large-diameter orifices 524 may have a constant cross-section. The size of the diameters may vary depending on the sound power level and frequency requirements. In general, the diameter of the relatively small-diameter orifices 522 may be decreased to target higher frequencies and the diameter of the relatively larger-diameter orifices 524 may be increased to target lower frequencies.

As illustrated in FIG. 10, the corners 634 defined between the orifices and the material of nozzle may be rounded, e.g., beveled, in order to minimize flow jetties or turbulence from the air or water traveling through the orifices. Minimizing the flow jetties and turbulences may help to reduce sound power level concentrations and sound wave amplitudes. Thus, the dishwasher 10 may in some embodiments incorporate a fluid inlet, for example, in accordance with the disclosure of U.S. patent application Ser. No. 12/362,262.

Accordingly, the dishwasher 10 may include various embodiments of features configured to reduce sound emissions therefrom. In various combinations, the above-described embodiments of the dishwasher 10 may synergistically contribute to reduced sounds emissions. In this regard, for example, the combination of a mastic-less dishwasher with a mastic-less material in accordance with U.S. patent application Ser. No. 12/360,600, a base tray in accordance with U.S. patent application Ser. No. 12/360,700, and/or a fluid inlet in accordance with U.S. patent application Ser. No. 12/362,262 may reduce the sound emissions further than may occur without inclusion of one or more of these optional embodiments. Accordingly, the dishwasher 10 may benefit from various combinations of the embodiments disclosed herein.

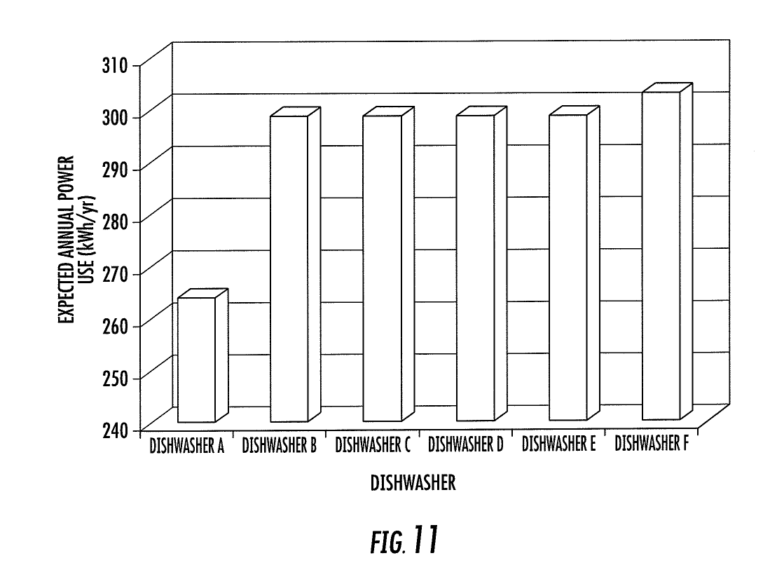

In this regard, Applicants have tested embodiments of the mastic-less dishwasher 10 under the acoustic standards within the International Electrotechnical Commission (IEC) sections 607.04-2, 3, 4 and compared them to embodiments of dishwashers including mastic materials. The test results indicate that the sound intensity of the mastic-less dishwasher 10 may be within one decibel of a dishwasher employing a mastic material through the one kilohertz to 4 kilohertz frequency range. Further, Applicants have found that peak sound intensity of embodiments of the mastic-less dishwasher 10 may be within four decibels of a dishwasher incorporating a mastic material. Accordingly, the mastic-less dishwasher 10 may emit substantially similar intensities of noise as compared to a dishwasher incorporating a mastic material while realizing various benefits as discussed herein. FIG. 11 illustrates expected annual power usage data associated with various embodiments of dishwashers. Expected annual power usage in kilowatt hours per year (kWh/yr) is listed for each of Dishwashers A-F. Expected annual power usage is based on standards provided in 10 Code of Federal Regulations Part 430- Energy Conservation Program for Consumer Products. Dishwasher A is a mastic-less dishwasher, whereas Dishwashers B-F are dishwashers including a mastic material.

As illustrated, Dishwasher A has the lowest expected annual power usage. In particular, Dishwasher A has an expected annual power usage of 264 kilowatt hours/year, whereas Dishwashers B-E have an expected annual power usage of 299 kilowatt hours/year and Dishwasher F has an expected annual power usage of 303 kilowatt hours/year. Accordingly, Dishwasher A has an expected annual power usage that is 35 kilowatt hours/year less than the lowest expected annual power usage of the remaining tested dishwashers. In this regard, Dishwasher A, which does not comprise a mastic material, is expected to use over eleven percent less energy over the course of a year. Accordingly, embodiments of the mastic-less dishwasher 10 provide unexpected results in terms of energy efficiency gains in comparison to dishwashers employing mastic materials.

Further, the mastic-less dishwasher 10 may provide benefits in terms of improved drying performance. In this regard, more heat may be retained in the mastic-less dishwasher as a result of not employing a mastic material, which may act as a heat sink as described above. In this regard Applicant has performed drying performance tests on embodiments of the mastic-less dishwasher 10. The test results yielded dry performance scores between 49 and 71 percent, whereas an embodiment of a dishwasher employing a mastic material yielded a dry performance score of 43 percent. These values are calculated based on performance tests whereby dust is applied to dishware in the dishwashers after completion of a wash cycle, and the amount of dust remaining on the dishware after completion of the dry cycle is measured. Accordingly, the mastic-less dishwasher 10 also provides unexpected results in terms of improved drying performance, which may enable the mastic-less dishwasher 10 to dry dishes more quickly than may occur in embodiments of dishwashers employing mastic materials.

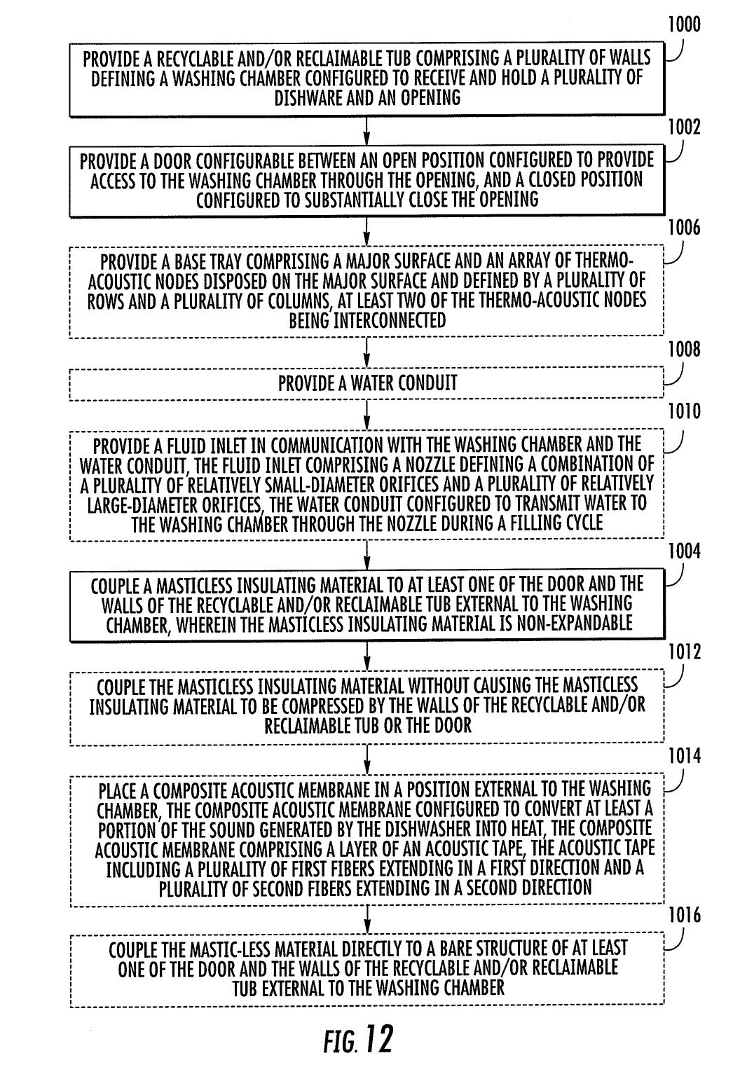

In a further embodiment a method for assembling a mastic-less dishwasher is provided. In some embodiments the dishwasher may comprise an embodiment of the above described dishwasher 10. As illustrated in FIG. 12, the method may include steps such as providing a tub comprising a plurality of walls defining a washing chamber configured to receive and hold a plurality of dishware and an opening at operation 1000. The method may further comprise the step of providing a door moveable between an open position configured to provide access to the washing chamber through the opening, and a closed position configured to substantially close the opening at operation 1002. Additionally, the method may include the step of coupling a mastic-less material to at least one of the door and the walls of the tub external to the washing chamber, wherein the mastic-less material is non-expandable at operation 1004. In some embodiments the method may provide for assembly of a dishwasher free of a mastic material such that during operation the dishwasher is configured to provide greater energy efficiency than a dishwasher comprising a mastic material.

In some embodiments, certain ones of the above-described operations (as illustrated in solid lines in FIG. 12) may be modified or combined with other steps (some examples of which are shown in dashed lines in FIG. 12). It should be appreciated that each of the modifications and optional additions may be included with the above-described operations (1000-1004) either alone or in combination with any others described herein.

For example, the method may further comprise the step of providing a base tray comprising a major surface and an array of thermo-acoustic nodes disposed on the major surface and defined by a plurality of rows and a plurality of columns, at least two of the thermo-acoustic nodes being interconnected at operation 1006. The base tray may be configured to channel a plurality of thermo-acoustic waves associated with noise generated by the dishwasher in an operational state between the thermo-acoustic nodes so as to control and manage the thermo-acoustic waves and to thereby attenuate the noise associated with the thermo-acoustic waves in some embodiments of the method.

Additionally, the method may include the step of providing a water conduit at operation 1008. Also, the method may include the step of providing a fluid inlet in communication with the washing chamber and the water conduit, the fluid inlet comprising a nozzle defining a combination of a plurality of relatively small-diameter orifices and a plurality of relatively large-diameter orifices, the water conduit configured to transmit water to the washing chamber through the nozzle during a filling cycle at operation 1010. Further, in some embodiments the step of coupling the mastic-less material at operation 1004 may comprise the step of coupling the mastic-less material comprises coupling the mastic-less material without causing the mastic-less material to be compressed by the walls of the tub or the door at operation 1012. Also, in some embodiments the step of coupling the mastic-less material at operation 1004 may comprise the step of placing a composite acoustic membrane in a position external to the washing chamber, the composite acoustic membrane configured to convert at least a portion of the sound generated by the dishwasher into heat, the composite acoustic membrane comprising a layer of an acoustic tape, the acoustic tape including a plurality of first fibers extending in a first direction and a plurality of second fibers extending in a second direction at operation 1014. Further, the step of coupling the mastic-less material at operation 1004 may comprise the step of coupling the mastic-less material directly to a bare structure of at least one of the door and the walls of the recyclable and/or reclaimable tub external to the washing chamber at operation 1016.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mastic-less dishwasher comprising:
a recyclable and/or reclaimable tub comprising a plurality of walls defining:
a washing chamber configured to receive and hold a plurality of dishware; and
an opening;
a door movable between an open position configured to provide access to the washing chamber through the opening, and a closed position configured to substantially close the opening; and
a mastic-less material coupled to at least one of the door and the walls of the recyclable and/or reclaimable tub external to the washing chamber,
wherein the mastic-less material is non-expandable, and
wherein the dishwasher is free of a mastic material such that during operation the mastic-less material does not expand and the dishwasher is configured to provide greater energy efficiency than a dishwasher comprising a mastic material.

2. The mastic-less dishwasher of claim 1, wherein the mastic-less material comprises a composite acoustic membrane including a layer of an acoustic tape, the acoustic tape comprising a plurality of first fibers extending in a first direction and a plurality of second fibers extending in a second direction, the first and second directions perpendicular to each other form a grid-like pattern,
wherein the acoustic tape is positioned and configured to convert at least a portion of a sound power level generated by the dishwasher into heat such that the sound power level outside the dishwasher is reduced.

3. The mastic-less dishwasher of claim 2, wherein the composite acoustic membrane further includes a first foam layer configured to absorb at least a portion of the sound power level and to reduce the speed of the sound power level prior to the sound power level reaching the acoustic tape.

4. The mastic-less dishwasher of claim 3, wherein the composite acoustic membrane further includes a second foam layer and a vinyl layer between the first and second foam layers, the vinyl layer being configured to convert at least a portion of the sound power level into heat.

5. The mastic-less dishwasher of claim 1, wherein the mastic-less material comprises a laminated structure positioned and configured to attenuate a sound power level generated by the dishwasher, the laminated structure including a layer of an acoustic tape, the acoustic tape comprising a non-fibrous layer and a plurality of fibers mounted thereon, and wherein the plurality of fibers is configured to convert at least a portion of a sound power level generated by the dishwasher into heat such that the sound power level outside the dishwasher is reduced.

6. The mastic-less dishwasher of claim 1, wherein at least one of the door and the walls of the recyclable and/or reclaimable tub define an inner wall that is exposed to the washing chamber, wherein an air gap is defined between the inner wall and the mastic-less material.

7. The mastic-less dishwasher of claim 6, wherein at least one of the door and the walls of the recyclable and/or reclaimable tub further define an intermediate wall defined between the inner wall and the mastic-less material.

8. The mastic-less dishwasher of claim 7, wherein at least one of the door and the walls of the recyclable and/or reclaimable tub further define an outer wall configured to be exposed to an outside environment,
wherein the mastic-less material is positioned between the intermediate wall and the outer wall and configured to contact both the intermediate wall and the outer wall.

9. The mastic-less dishwasher of claim 1, wherein the mastic-less material comprises a composite cellular membrane comprising a cell layer positioned between a first reflective layer and a second reflective layer.

10. The mastic-less dishwasher of claim 1, wherein the door and the walls of the recyclable and/or reclaimable tub comprise a plurality of stainless steel panels.

11. The mastic-less dishwasher of claim 1, further comprising a base tray configured to manage and control thermo-acoustic waves associated with noise generated by the dishwasher in an operational state, wherein the thermo-acoustic waves comprise vibrations and/or sound waves, the base tray comprising:
a major surface; and
an array of thermo-acoustic nodes disposed on the major surface and defined by a plurality of rows and a plurality of columns, at least two of the thermo-acoustic nodes being interconnected and configured to channel the thermo-acoustic waves therebetween so as to control and manage the thermo-acoustic waves, thereby attenuating the noise associated with the thermo-acoustic waves.

12. The mastic-less dishwasher of claim 1, further comprising:
a water conduit; and
a fluid inlet in communication with the washing chamber and the water conduit, the fluid inlet comprising a nozzle defining a combination of a first plurality of orifices and a second plurality of orifices that define a diameter that is relatively larger than the diameter of the first plurality of orifices, wherein, during a filling cycle of the dishwasher, water is transmitted along the water conduit through the nozzle to the washing chamber.

13. The mastic-less dishwasher of claim 12, wherein each of the first plurality of orifices and the second plurality of orifices define a constant cross-section in a water inflow direction.

14. The mastic-less dishwasher of claim 12, wherein the nozzle comprises an inner surface and an outer surface,
wherein each of the first plurality of orifices extends from the inner surface to the outer surface and defines a constant cross-section there along, and
wherein each of the second plurality of orifices extends from the inner surface to the outer surface and defines a diverging cross-section there along.

15. The mastic-less dishwasher of claim 1, wherein the mastic-less material is coupled directly to a bare structure of at least one of the door and the walls of the recyclable and/or reclaimable tub external to the washing chamber.

16. A mastic-less dishwasher comprising:
a recyclable and/or reclaimable tub comprising a plurality of walls defining:
a washing chamber configured to receive and hold a plurality of dishware; and
an opening;
a door moveable between an open position configured to provide access to the washing chamber through the opening, and a closed position configured to substantially close the opening; and
a mass dampener material coupled to at least one of the door and the walls of the recyclable and/or reclaimable tub,
wherein the mass dampener material comprises a mastic-less material, and
wherein the dishwasher is free of a mastic material such that during operation the dishwasher is configured to provide greater energy efficiency than a dishwasher comprising a mastic material.

17. The mastic-less dishwasher of claim 16, wherein the mass dampener material comprises a vinyl layer configured to convert at least a portion of a sound power level generated by the dishwasher into heat such that the sound power level outside the dishwasher is reduced.

18. A method for assembling a mastic-less dishwasher, comprising:
providing a recyclable and/or reclaimable tub comprising a plurality of walls defining:
a washing chamber configured to receive and hold a plurality of dishware; and
an opening;
providing a door movable between an open position configured to provide access to the washing chamber through the opening, and a closed position configured to substantially close the opening; and
coupling a mastic-less material to at least one of the door and the walls of the recyclable and/or reclaimable tub external to the washing chamber,
wherein the mastic-less material is non-expandable, and
wherein the dishwasher is free of a mastic material such that during operation the dishwasher is configured to provide greater energy efficiency than a dishwasher comprising a mastic material.

19. The method of claim 18, wherein coupling the mastic-less material comprises coupling the mastic-less material without causing the mastic-less material to be compressed by the walls of the recyclable and/or reclaimable tub or the door.

20. The method of claim 18, wherein coupling the mastic-less material comprises placing a composite acoustic membrane in a position external to the washing chamber, the composite acoustic membrane configured to convert at least a portion of the sound generated by the dishwasher into heat, the composite acoustic membrane comprising a layer of an acoustic tape, the acoustic tape including a plurality of first fibers extending in a first direction and a plurality of second fibers extending in a second direction.

21. The method of claim 18, further comprising providing a base tray comprising:
a major surface; and
an array of thermo-acoustic nodes disposed on the major surface and defined by a plurality of rows and a plurality of columns, at least two of the thermo-acoustic nodes being interconnected,
wherein the base tray is configured to channel a plurality of thermo-acoustic waves associated with noise generated by the dishwasher in an operational state between the thermo- acoustic nodes so as to control and manage the thermo-acoustic waves and to thereby attenuate the noise associated with the thermo-acoustic waves.

22. The method of claim 18, further comprising:
providing a water conduit; and
providing a fluid inlet in communication with the washing chamber and the water conduit, the fluid inlet comprising a nozzle defining a combination of a plurality of relatively small-diameter orifices and a plurality of relatively large-diameter orifices, the water conduit configured to transmit water to the washing chamber through the nozzle during a filling cycle.

23. The method of claim 18, wherein coupling the mastic-less material to at least one of the door and the walls of the recyclable and/or reclaimable tub external to the washing chamber comprises coupling the mastic-less material directly to a bare structure of at least one of the door and the walls of the recyclable and/or reclaimable tub external to the washing chamber.
